(19) United States
(12) Patent Application Publication
(10) Pub. No.: US 2025/0256576 A1
(43) Pub. Date: Aug. 14, 2025

(54) Verification Method, Apparatus And System For Icon Image Of Dashboard

(71) Applicant: XG Tech PTE. LTD., Singapore (SG)

(72) Inventors: Zhiqun ZHANG, Singapore (SG); Jianfeng YU, Singapore (SG)

(73) Assignee: XG Tech PTE. LTD., Singapore (SG)

(21) Appl. No.: 19/196,728

(22) Filed: May 1, 2025

(30) Foreign Application Priority Data
Oct. 28, 2024 (CN) 2024115167330

(51) Int. Cl. B60K 35/28; B60K 35/22; G06T 7/00; G06T 7/73; G06T 11/00

(52) U.S. Cl. CPC B60K 35/28; B60K 35/22; G06T 7/0002; G06T 7/73; G06T 11/00; B60K 2360/119

(57) ABSTRACT

The present disclosure relates to the technical field of intelligent driving, and discloses a verification method, apparatus and system for an icon image of a dashboard. In the verification method, a to-be-verified icon image is determined from an image currently displayed on the dashboard, a first verification value of the to-be-verified icon image is determined, and then a target icon image corresponding to the to-be-verified icon image is determined from at least one stored icon image of the dashboard; a second verification value of the target icon image is determined; and a display status of the to-be-verified icon image currently displayed on the dashboard is verified based on the first verification value and the second verification value.

### CROSS-REFERENCE TO RELATED APPLICATION

This application claims priority to Chinese Patent Application No. 2024115167330, filed on Oct. 28, 2024, the entire disclosure of which is incorporated herein by reference.

### FIELD

The present disclosure relates to a field of intelligent driving technology, and in particular, to a verification method, apparatus and system for an icon image of a dashboard.

### BACKGROUND

As intelligent driving technology develops, application of smart cockpits is becoming increasingly popular. A smart cockpit is a cockpit that integrates various intelligent technologies, and the smart cockpit is typically provided with a dashboard located in front of a driver seat.

The dashboard may display images (that is, icon images) of various icons (that is, Telltale) indicating statuses of a vehicle, such as an icon image indicating whether a fault occurs in an anti-lock braking system of the vehicle, and an icon image indicating whether a parking brake is in a working state.

When driving a vehicle, a driver typically views icon images displayed on a dashboard to determine a vehicle status. In this case, whether the dashboard correctly displays the icon images is critical for driving safety. Therefore, verifying a display status of an icon image currently displayed on a dashboard has become a problem that needs to be resolved urgently.

### SUMMARY

To resolve the technical problem described above, the present disclosure provides a verification method, apparatus and system for an icon image of a dashboard, to implement verification of a display status of an icon image currently displayed on a dashboard.

According to a first aspect of the present disclosure, there is provided a verification method for an icon image of a dashboard, including:
determining a to-be-verified icon image from an image currently displayed on the dashboard;
determining a first verification value of the to-be-verified icon image;
determining, from at least one stored icon image of the dashboard, a target icon image corresponding to the to-be-verified icon image;
determining a second verification value of the target icon image; and
verifying, based on the first verification value and the second verification value, a display status of the to-be-verified icon image currently displayed on the dashboard.

According to a second aspect of the present disclosure, there is provided a verification apparatus for an icon image of a dashboard, including:
a first image determination module configured for determining a to-be-verified icon image from an image currently displayed on the dashboard;
a first verification value determination module configured for determining a first verification value of the to-be-verified icon image determined by the first image determination module;
a second image determination module configured for determining, from at least one stored icon image of the dashboard, a target icon image corresponding to the to-be-verified icon image;
a second verification value determination module configured for determining a second verification value of the target icon image determined by the second image determination module; and
a verification module configured for verifying, based on the first verification value determined by the first verification value determination module and the second verification value determined by the second verification value determination module, a display status of the to-be-verified icon image currently displayed on the dashboard.

According to a third aspect of the present disclosure, there is provided a non-transitory computer readable storage medium, on which a computer program is stored, where the computer program when executed by a processor, causes the processor to implement the verification method for an icon image of a dashboard according to the first aspect.

According to a fourth aspect of the present disclosure, there is provided an electronic device, including:
a processor; and
a memory configured for storing instructions executable by the processor, where
the processor is configured for reading the executable instructions from the memory and executing the instructions to implement the verification method for an icon image of a dashboard according to the first aspect.

According to a fifth aspect of the present application, there is provided a computer program product, where instructions in the computer program product, when executed by a processor, cause the processor to implement the verification method for an icon image of a dashboard according to the first aspect.

Embodiments of the present disclosure provide a verification method, apparatus and system for an icon image of a dashboard. In the verification method, first, a to-be-verified icon image is determined from an image currently displayed on the dashboard, and a first verification value of the to-be-verified icon image is determined. Then, a target icon image corresponding to the to-be-verified icon image is determined from at least one stored icon image of the dashboard, and a second verification value of the target icon image is determined. Subsequently, a display status of the to-be-verified icon image currently displayed on the dashboard is verified based on the first verification value and the second verification value. In other words, through the solution provided in the embodiments of the present disclosure, a display status of an icon image currently displayed on a dashboard may be verified.

Furthermore, in the prior art, a display status of a to-be-verified icon image currently displayed on a dashboard cannot be verified. Therefore, it is possible that a driver drives a vehicle under incorrect display of the to-be-verified icon image. Meanwhile, the driver typically needs to view an icon image displayed on dashboard to determine a vehicle status during driving. If the to-be-verified icon image is currently displayed on the dashboard incorrectly, the driver may acquire an incorrect vehicle status when viewing the dashboard, reducing safety of driving the vehicle. However, the solution of the present disclosure enables a driver of a vehicle to determine the display status based on a verification result, helping to reduce occurrence of the driver driving the vehicle under incorrect display of a to-be-verified icon image, thereby helping to improve safety of vehicle driving.

### BRIEF DESCRIPTION OF DRAWINGS

FIG. 1(a) is a schematic diagram illustrating an icon image;

FIG. 1(b) is a schematic diagram illustrating another icon image;

FIG. 1(c) is a schematic diagram illustrating another icon image;

FIG. 2 is a schematic diagram illustrating an architecture in which an image currently displayed on a dashboard includes an icon image;

FIG. 3 is a schematic diagram illustrating image superposing by a display processing unit;

FIG. 4 is a schematic flowchart illustrating a verification method for an icon image of a dashboard according to an exemplary embodiment of the present disclosure;

FIG. 5(a) is a schematic diagram illustrating a background image of a dashboard according to an exemplary embodiment of the present disclosure;

FIG. 5(b) is a schematic diagram illustrating an image currently displayed on a dashboard according to an exemplary embodiment of the present disclosure;

FIG. 5(c) is a schematic diagram illustrating an image currently displayed on a dashboard according to another exemplary embodiment of the present disclosure;

FIG. 6 is a schematic flowchart illustrating a verification method for an icon image of a dashboard according to another exemplary embodiment of the present disclosure;

FIG. 7 is a schematic flowchart illustrating a verification method for an icon image of a dashboard according to another exemplary embodiment of the present disclosure;

FIG. 8 is a schematic flowchart illustrating a verification method for an icon image of a dashboard according to another exemplary embodiment of the present disclosure;

FIG. 9 is a schematic flowchart illustrating determining of a second pixel in a verification method for an icon image of a dashboard according to an exemplary embodiment of the present disclosure;

FIG. 10 is a schematic flowchart illustrating a verification method for an icon image of a dashboard according to another exemplary embodiment of the present disclosure;

FIG. 11 is a schematic flowchart illustrating a verification method for an icon image of a dashboard according to another exemplary embodiment of the present disclosure;

FIG. 12 is a schematic diagram illustrating an architecture in which an image currently displayed on a dashboard includes an icon image according to an exemplary embodiment of the present disclosure;

FIG. 13 is a schematic flowchart illustrating a verification method for an icon image of a dashboard according to another exemplary embodiment of the present disclosure;

FIG. 14 is a schematic diagram illustrating a structure of a verification apparatus for an icon image of a dashboard according to an exemplary embodiment of the present disclosure;

FIG. 15 is a schematic diagram illustrating a structure of a verification apparatus for an icon image of a dashboard according to another exemplary embodiment of the present disclosure; and

FIG. 16 is a schematic diagram illustrating a structure of an electronic device according to an exemplary embodiment of the present disclosure.

### DETAILED DESCRIPTION

To explain the present disclosure, exemplary embodiments of the present disclosure will be described in detail below with reference to the accompanying drawings. Apparently, the described embodiments are merely some, not all, of embodiments of the present disclosure. It should be understood that, the present disclosure is not limited by the exemplary embodiments.

It should be noted that the relative arrangement of components and steps, numerical expressions, and numerical values set forth in these embodiments do not limit the scope of the present disclosure, unless otherwise specifically stated.

### Application Overview

A vehicle is typically provided with a dashboard in front of a driver seat. The dashboard is an important interface for a driver to interact with the vehicle, and may typically display images (that is, icon images) of various icons (that is, Tale tells). The icon image may provide the driver with various key information on the vehicle.

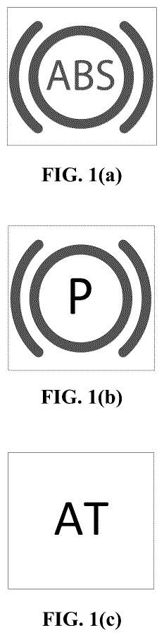

For example, an icon image shown in FIG. 1(a) indicates whether a fault occurs in an anti-lock braking system of a vehicle, an icon image shown in FIG. 1(b) indicates whether a parking brake of a vehicle is in a working state, and an icon image shown in FIG. 1(c) indicates a warning signal light for an automatic transmission.

To display an icon on the dashboard, at present, various icon images are typically pre-stored in a memory, and the memory also stores a background image of the dashboard. In this case, the various icon images and the background image may be read from the memory, then the icon images are superimposed onto different areas of the background image to obtain a superimposed image, and then the superimposed image is forwarded to a display panel of the dashboard. The display panel displays the superimposed image.

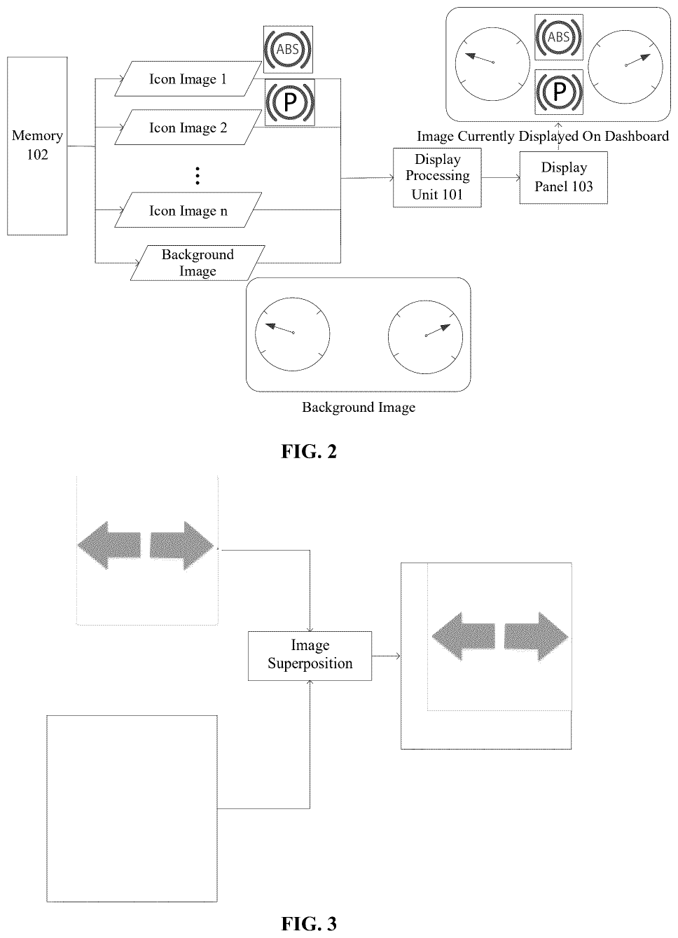

To clarify a process of displaying a current image on the dashboard, an example is provided below. FIG. 2 is a schematic diagram corresponding to the example. Referring to FIG. 2, at present, the following manner is typically used to enable an image currently displayed on the dashboard to include an icon image.

First, a display processing unit 101 reads respective icon images and a background image of the dashboard from a memory 102. In the example corresponding to FIG. 2, the display processing unit 101 reads, from the memory 102, a plurality of pre-stored icon images, which include an icon image 1, an icon image 2, . . . , and an icon image n, n being a positive integer. The icon image 1 is the icon image shown in FIG. 1(a), the icon image 2 is the icon image shown in FIG. 1(b), and the background image is an image with two circular instrument dials shown in FIG. 2. To clarify the background image in the example of FIG. 2, a text of “Background Image” is annotated below the background image shown in FIG. 2.

Next, the display processing unit 101 superimposes the icon images onto the background image according to positions of the icon images on the dashboard to obtain a superimposed image, that is, the icon images and the background image are combined into an image.

Subsequently, the display processing unit 101 forwards the superimposed image to a display panel 103 of the dashboard, and the display panel 103 displays the superimposed image, thus enabling the image currently displayed on the dashboard to include the icon images. To clarify the image currently displayed on the dashboard in the example of FIG. 2, a text of “Image Currently Displayed On Dashboard” is annotated below the image currently displayed on the dashboard shown in FIG. 2.

In FIG. 2, an image shown above the display panel 103 is the superimposed image after the icon image 1 and the icon image 2 read from the memory 102 are superimposed onto the background image, that is, the image currently displayed on the dashboard.

The solution provided in the foregoing description may enable the image currently displayed on the dashboard to include an icon image. However, in some cases, the icon image currently displayed on the dashboard may be incorrect. For example, when images other than the icon images are stored in the memory 102, the display processing unit 101 may read an image other than the icon image from the memory 102; alternatively, when the display processing unit 101 superimposes icon images onto the background image, some icon images might be superimposed to incorrect positions on the background image, which may both lead to an incorrect icon image displayed on the dashboard.

When driving a vehicle, a driver needs to view an icon image displayed on a dashboard to determine a status of the vehicle. Therefore, correctness of the icon image displayed on the dashboard is critical for driving safety. Therefore, at present, there is an urgent need for a solution that may verification a display status of an icon image currently displayed on a dashboard.

To resolve this problem, the present disclosure provides a verification method for an icon image of a dashboard. In this method, a to-be-verified icon image is determined from an image currently displayed on the dashboard, and then a first verification value of the to-be-verified icon image is determined; next, a target icon image corresponding to the to-be-verified icon image is determined from at least one stored icon image of the dashboard, and a second verification value of the target icon image is determined; and a display status of the to-be-verified icon image currently displayed on the dashboard is verified based on the first verification value and the second verification value. Through this solution, based on the second verification value corresponding to the pre-stored target icon image, verification of a display status of an icon image currently displayed on the dashboard may be further implemented, thereby helping improve safety of driving a vehicle.

### Exemplary System

The embodiments of the present disclosure may be applied to an application scenario in which an icon image currently displayed on a dashboard needs to be verified, to verification a display status of the icon image.

In a feasible implementation, the verification method provided in the embodiments of the present disclosure may be applied to a vehicle. The vehicle includes a dashboard, a memory, and a display processing unit. The memory is configured for storing icon images to be displayed on the dashboard. Typically, each of the icon images is stored in the memory in a form of a separate image file. The display processing unit may read the icon images from the memory, and superimpose each of the icon images to a corresponding position on a background image to obtain a superimposed image, that is, the icon images and the background image are combined into an image, and then forward the superimposed image to a display panel of the dashboard, so that the display panel displays the image, thereby enabling an image currently displayed on the dashboard to include the icon images.

To clarify a manner in which the display processing unit determines the superimposed image, the present disclosure provides FIG. 3. On the left side of FIG. 3, there are two parallel images, with a lower image being slightly larger and including vertical stripes, which may be considered as a background image, and an upper image being slightly smaller, which may be considered as an icon image. The display processing unit may perform image superposition on the two images on the left side of FIG. 3 to obtain a superimposed image, which is shown on the right side of FIG. 3.

Furthermore, the vehicle may further include a processor. If a display status of a to-be-verified icon image displayed on the dashboard needs to be verified, the processor may determine the to-be-verified icon image from an image displayed on the dashboard and determine a first verification value. Moreover, the processor may further determine, from at least one stored icon image of the dashboard, a target icon image corresponding to the to-be-verified icon image, and determine a second verification value of the target icon image.

The processor may determine the second verification value in various manners.

In a feasible implementation, the processor determines the second verification value through a verification manner in accordance with a verification manner of determining the first verification value. Alternatively, in a feasible implementation, the second verification value may be obtained and stored in the memory by verifying the target icon image in advance, and the processor may read the second verification value stored in the memory.

After determining the second verification value, the processor verifications, based on the first verification value and the second verification value, a display status of the to-be-verified icon image currently displayed on the dashboard.

Through the solution provided in the present disclosure, a display status of an icon image currently displayed on a dashboard may be verified. Further, the solution helps a driver of a vehicle to determine the display status of the icon image according to a verification result, thereby helping improve safety of vehicle driving.

### Exemplary Method

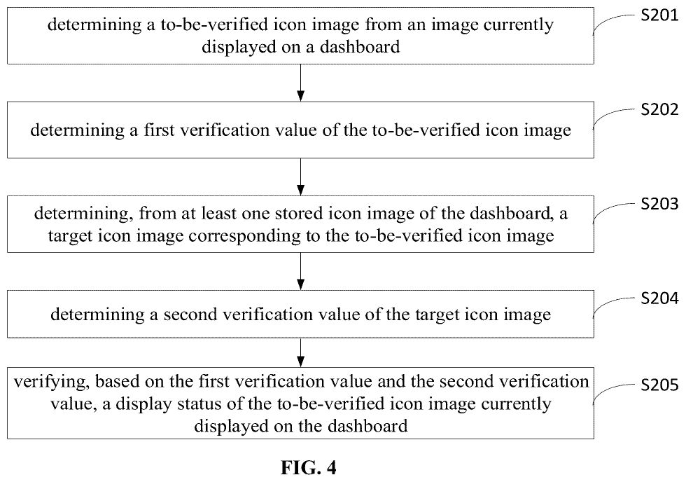

FIG. 4 is a schematic flowchart illustrating a verification method for an icon image of a dashboard according to an exemplary embodiment of the present disclosure, which may be applied to a processor of a vehicle. As shown in FIG. 4, the verification method includes the following steps:

Step S201: determining a to-be-verified icon image from an image currently displayed on the dashboard.

According to the foregoing description of the manner of displaying an image displayed on the dashboard and FIG. 2, the image displayed on the dashboard is determined by superimposing a plurality of icon images onto the background image. Therefore, in a feasible implementation, the to-be-verified icon image may be determined by cropping the to-be-verified icon image from the image currently displayed on the dashboard.

In this implementation, position information of a distribution area of the to-be-verified icon image in the image currently displayed on the dashboard may be pre-stored, so that the to-be-verified icon image may be cropped, based on the position information, from the image currently displayed on the dashboard.

For example, if the to-be-verified icon image is a rectangle, the position information may include position coordinates of four vertices of the rectangle in the image currently displayed on the dashboard. If the to-be-verified icon image is a circle, the position information may include position coordinates of a center of the circle in the image currently displayed on the dashboard and a radius length of the circle.

Step S202: determining a first verification value of the to-be-verified icon image.

In this step, pixels of the to-be-verified icon image may be verified through a preset verification algorithm to determine the first verification value. For example, the verification algorithm may include one of cyclic redundancy verification (CRC) algorithms, for example, a CRC32 algorithm.

Certainly, the verification algorithm may further include another verification algorithm, which is not limited in the present disclosure.

Step S203: determining, from at least one stored icon image of the dashboard, a target icon image corresponding to the to-be-verified icon image.

At least one icon image to be displayed on the dashboard is stored in a memory. Different icon images are distributed in different areas of the image displayed on the dashboard. In this embodiment of the present disclosure, a correspondence between image information (such as an image number or name) of each icon image and position information of a corresponding area in the image currently displayed on the dashboard may be pre-stored. In step S203, image information corresponding to the position information of the to-be-verified icon image may be determined according to the position information of the to-be-verified icon image in the image currently displayed on the dashboard and the correspondence, and then a target icon image indicated by the image information is determined from the icon images stored in the memory based on the image information.

For example, an icon image 1 and an icon image 2 are stored in the memory. The correspondence indicates that first location information corresponds to an image name (for example, “an ABS icon”) of the icon image 1 and that second location information corresponds to an image number (for example, “number 02”) of the icon image 2.

In this case, if the position information of the to-be-verified icon image on the dashboard is the first location information, the image name of the ABS icon corresponding to the first location information may be determined based on the correspondence, and the icon image 1 with the image name may be further determined as a target image.

Alternatively, if the position information of the to-be-verified icon image on the dashboard is the second location information, the image number of number 02 corresponding to the second location information may be determined based on the correspondence, and the icon image with the number 02 may be further determined as a target image.

Step S204: determining a second verification value of the target icon image.

Optionally, the second verification value may be pre-stored in the memory, and the second verification value corresponding to the target icon image may be directly read. Alternatively, a display processing unit verifications the target icon image to obtain the second verification value.

Step S205: verifying, based on the first verification value and the second verification value, a display status of the to-be-verified icon image currently displayed on the dashboard.

In the present disclosure, the display status may include correct display and incorrect display. If the first verification value and the second verification value indicate a higher similarity between the to-be-verified icon image and the target icon image, the display status of the to-be-verified icon image currently displayed on the dashboard is correct display; and if the first verification value and the second verification value indicate a lower similarity between the to-be-verified icon image and the target icon image, the display status of the to-be-verified icon image currently displayed on the dashboard is incorrect display.

The embodiments of the present disclosure provide a verification method, apparatus and system for an icon image of a dashboard. In the verification method, first, a to-be-verified icon image is determined from an image currently displayed on the dashboard, and a first verification value of the to-be-verified icon image is determined. Then, a target icon image corresponding to the to-be-verified icon image is determined from at least one stored icon image of the dashboard, and a second verification value of the target icon image is determined. Subsequently, a display status of the to-be-verified icon image currently displayed on the dashboard is verified based on the first verification value and the second verification value. In other words, through the solution provided in the embodiments of the present disclosure, a display status of an icon image currently displayed on a dashboard may be verified.

Furthermore, because a display status of a to-be-verified icon image currently displayed on a dashboard cannot be verified in the prior art, it is possible that a driver drives a vehicle under incorrect display of the to-be-verified icon image. Meanwhile, the driver typically needs to view an icon image displayed on dashboard to determine a vehicle status during driving. If the to-be-verified icon image currently displayed on the dashboard is incorrect, as a result, an incorrect vehicle status may be acquired by the driver when viewing the dashboard, reducing safety of driving the vehicle. However, the solution of the present disclosure enables a driver of a vehicle to determine the display status based on a verification result, helping to reduce occurrence of the driver driving the vehicle under incorrect display of a to-be-verified icon image, thereby helping to improve safety of vehicle driving.

Moreover, in the description of the foregoing embodiment and the schematic diagram in FIG. 4, after the first verification value of the to-be-verified icon image is determined, the operation of determining, from at least one stored icon image of the dashboard, the target icon image corresponding to the to-be-verified icon image is performed. During an actual operation, the two steps are not performed strictly in chronological order. Alternatively, the operation of determining, from at least one stored icon image of the dashboard, the target icon image corresponding to the to-be-verified icon image may be performed after the to-be-verified icon image is determined, and the first verification value of the to-be-verified icon image is determined after the target icon image is determined. In other words, step S202 is performed after step S203. Alternatively, the two steps may be performed at the same time. This is not limited in the present disclosure.

According to the verification method provided in the embodiments of the present disclosure, the to-be-verified icon image currently displayed on the dashboard may be verified. The to-be-verified icon image typically includes an icon element (which may also be referred to as an icon subject) and an icon background. The icon element typically includes at least one of a letter, a graphic, and a symbol, which are used for constituting primary visual content and identification features of the icon. A part of the icon image other than the icon element is the icon background.

Referring to the schematic diagram shown in FIG. 1(a), icon elements in the icon image is in black, that is, the icon elements include black letters “ABS”, along with a black circular line and black curved lines around the letters, and the remaining part of the icon image is an icon background of the icon. Referring to the schematic diagram shown in FIG. 1(b), icon elements in the icon image are in black, that is, the icon elements include a black letter “P” along with a black circular line and black curved lines around the letter, and the remaining part is an icon background of the icon. Referring to the schematic diagram shown in FIG. 1(c), icon elements of the icon image are two black letters “A” and “T”, and the remaining part is an icon background of the icon image.

Based on whether an icon background is a transparent background, there are typically two types of icon images. In a first type, the icon background of the icon image is an opaque background. For example, the icon background of the icon image may be in pure black or pure white. In this case, after the icon image is superimposed onto the background image of the dashboard to obtain a superimposed image, both the icon element of the icon image and the icon background of the icon image are displayed in the superimposed image.

In a second type, the icon background of the icon image is a transparent background. Because the icon background of the icon image is a transparent background, after the icon image is superimposed onto the background image of the dashboard to obtain a superimposed image, only the icon element of the icon image is displayed in the superimposed image, and an area in which the icon background of the icon image is distributed may display a pattern in the background image of the dashboard.

Some vehicle users are more concerned about appearance of the dashboard and may customize the background image of the dashboard to make the background image display their favorite patterns. In this case, due to a transparent background of the icon image, the area, in the image displayed on the dashboard, in which the icon background of the icon image is distributed may display the pattern of the background image, increasing visual appeal of the dashboard and improving user experience. For example, the vehicle user may set the background image of the dashboard to be a landscape photograph. When the icon background of the icon image is a transparent background, an area, in the image currently displayed on the dashboard, in which the icon background of the icon image is distributed may display the scenery.

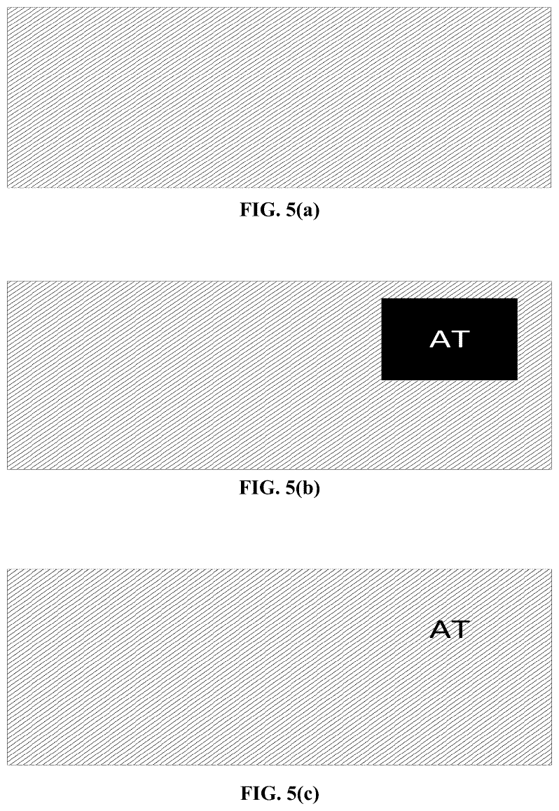

To clarify impact of the two types of icon images on the image displayed on the dashboard, the present disclosure provides an example, in which the icon image is a warning signal light for an automatic transmission, and the background image of the dashboard stored in the memory is, as shown in FIG. 5(a), an image including diagonal stripes.

In this example, if the icon image is of the first type, the icon background of the icon image is in pure black, and the icon image is located in an upper right corner of the image shown in FIG. 5(a), after the icon image is superimposed onto the background image of the dashboard to obtain a superimposed image, an area, in the superimposed image, in which the icon background of the icon image is distributed is still displayed in pure black. Correspondingly, the image displayed on the dashboard is shown in FIG. 5(b).

Alternatively, if the icon image is of the second type, that is, if the icon background of the icon image is a transparent background, after the icon image is superimposed onto the background image of the dashboard to obtain a superimposed image, an area, in the superimposed image, in which the icon background of the icon image is distributed displays a pattern displayed in the background image of the dashboard. Correspondingly, the image displayed on the dashboard is shown in FIG. 5(c).

Based on this example, it may be learned that the image currently displayed on the dashboard is different as the types of to-be-verified icon images are different. In addition, during generation of the image currently displayed on the dashboard, each of the icon images needs to be superimposed onto the background image of the dashboard. Therefore, if the to-be-verified icon image is of the second type, that is, if the icon background of the to-be-verified icon image is a transparent background, an area, in a superimposed image (that is, the image currently displayed on the dashboard), in which the icon background is located displays a pattern in the background image of the dashboard. Since the to-be-verified icon image is an icon image determined from the image currently displayed on the dashboard, the pattern in the background image of the dashboard is also displayed in the icon background of the to-be-verified icon image, while the icon background of the target icon image stored in the memory is still a transparent background.

In this case, even if the dashboard displays correctly the to-be-verified icon image, if pixels of the to-be-verified icon image is directly verified to obtain the first verification value, there is still a significant difference between the first verification value and the second verification value, and it may be generally determined, based on the first verification value and the second verification value, that the dashboard does not correctly display the to-be-verified icon image, leading to a verification error and resulting in lower verification accuracy.

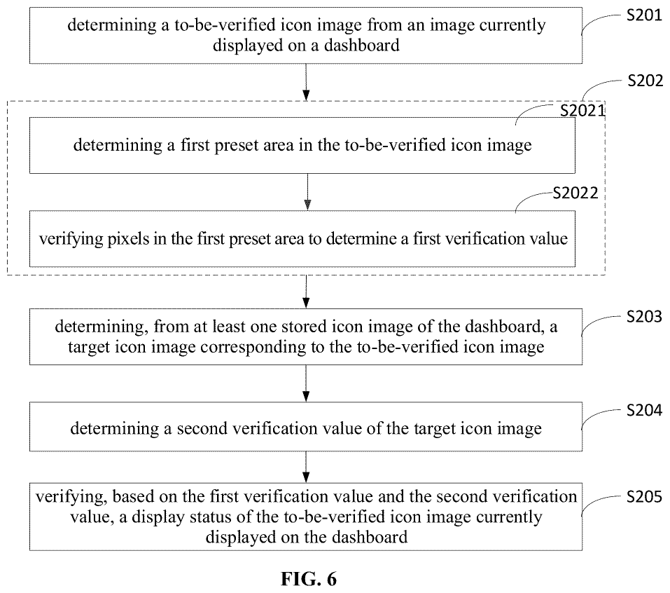

In this case, as shown in FIG. 6, based on the foregoing embodiment shown in FIG. 4, the operation of determining a first verification value of the to-be-verified icon image in step S202 of the present disclosure may include the following steps:

Step S2021: determining a first preset area in the to-be-verified icon image.

For example, the first preset area includes an opaque area in the to-be-verified icon image.

Step S2022: verifying pixels in the first preset area to determine the first verification value.

In this step, verification calculation may be performed on the pixels in the first preset area through a preset verification algorithm to determine the first verification value. The verification algorithm may include one of CRC algorithms, for example, a CRC32 algorithm.

Certainly, the verification algorithm may further include another verification algorithm, which is not limited in the present disclosure.

When the pattern in the background image is displayed in the icon background of the to-be-verified icon image, impact on verification accuracy may be reduced through the solution disclosed in this embodiment, thereby improving the verification accuracy.

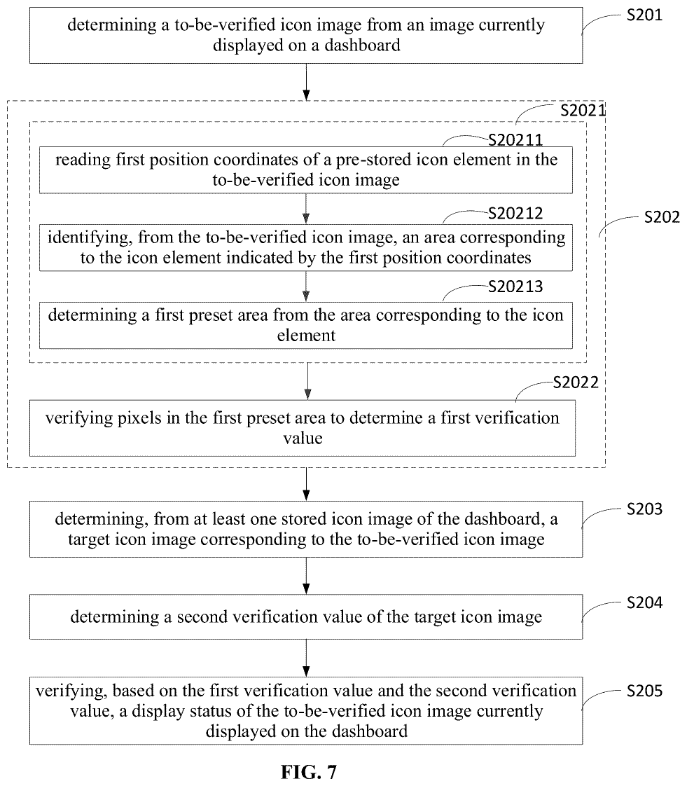

In the present disclosure, the first preset area may be determined through various feasible implementations. Referring to the schematic flowchart shown in FIG. 7, in one of the feasible implementations, the operation of determining a first preset area verification of the to-be-verified icon image includes the following steps:

Step S20211: reading first position coordinates of a pre-stored icon element in the to-be-verified icon image.

In this feasible implementation, the icon element in the to-be-verified icon image is predetermined, and then, the first position coordinates of the icon element in the to-be-verified icon image are determined and stored.

Step S20212: identifying, from the to-be-verified icon image, an area corresponding to the icon element indicated by the first position coordinates.

Through this operation, the identified area is an area in which the icon element is distributed in the to-be-verified icon image.

Step S20213: determining the first preset area from the area corresponding to the icon element.

This step may determine the first preset area in various manners. For example, this step may determine, as the first preset area, an entire area corresponding to the icon element indicated by the first position coordinates; or in another example, may determine, as the first preset area, a partial area (for example, an upper half area or a lower half area) corresponding to the icon element indicated by the first position coordinates. In other words, the pixels included in the first preset area are pixels of the icon element in the to-be-verified icon image.

Certainly, this step may further determine the first preset area from the area corresponding to the icon element in another manner, which is not limited in the present disclosure.

The first preset area may be determined through the operations in step S20211 to step S20213. Moreover, because the pixels included in the first preset area are pixels of the icon element in the to-be-verified icon image, the first verification value may be determined only in a manner of verifying the pixels of the icon element in the to-be-verified icon image, that is, the icon background of the to-be-verified icon image is not considered for the determining of the first verification value. In this case, even if the icon background of the to-be-verified icon image is a transparent background, the first verification value is not affected by the background image of the dashboard, thereby improving accuracy of verifying the to-be-verified icon image.

Further, even if the icon background of the to-be-verified icon image is an opaque background, the first preset area may still be determined through this solution. Therefore, this solution may be used not only for verifying a to-be-verified icon image with a transparent background, but also for verifying a to-be-verified icon image with an opaque background, achieving wide applications.

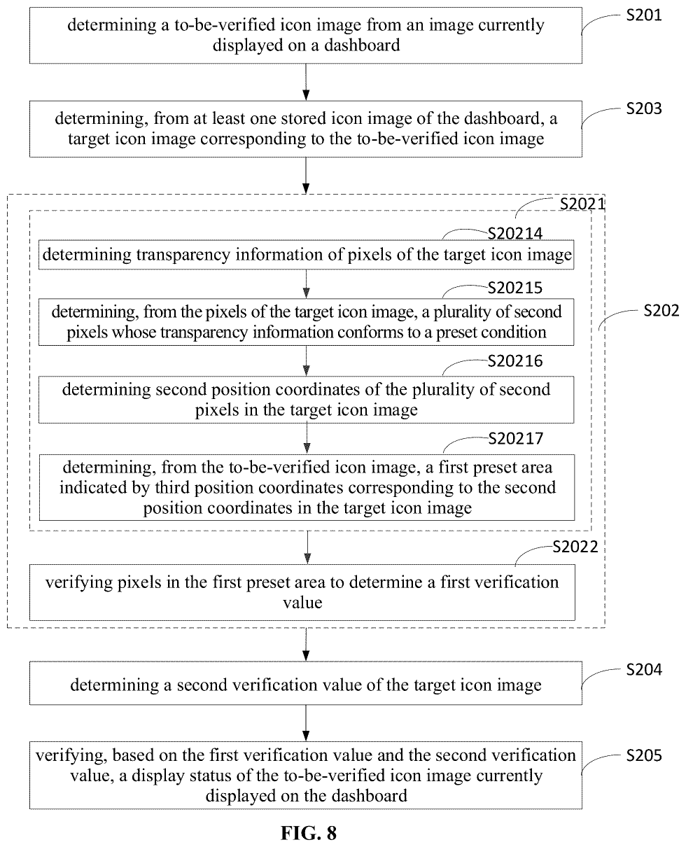

In another feasible implementation, the operation in step S202 may be performed after step S203, that is, the first verification value of the to-be-verified icon image is determined after the target icon image corresponding to the to-be-verified icon image is determined from at least one stored icon image of the dashboard. Referring to the schematic flowchart shown in FIG. 8, in this implementation, the operation of determining a first verification value of the to-be-verified icon image includes the following steps:

Step S20214: determining transparency information of pixels of the target icon image.

The transparency information is information used for representing a transparency degree of a pixel.

In a feasible implementation, the transparency information of the pixel may include transparency of the pixel. The transparency of the pixel may be represented by a value of an alpha channel of the pixel. The value of the alpha channel may indicate the transparency degree of the pixel. Typically, a larger value of an alpha channel of a pixel indicates a lower transparency degree of the pixel, and the value may be represented in various forms. In one representation form, the value may range from 0 (indicating that the pixel is fully transparent) to 1 (indicating that the pixel is fully opaque). Alternatively, in another representation form, the value may range from 0 (indicating that the pixel is fully transparent) to 255 (indicating that the pixel is fully opaque).

Further, the transparency information of the pixel may include opacity of the pixel. The opacity of the pixel may be represented by a value of an opacity attribute of the pixel. The value of the opacity attribute may indicate an opacity degree of the pixel. Typically, a larger value of an opacity attribute of a pixel indicates a higher transparency degree of the pixel, and the value may also be represented in various forms. In one representation form, the value may range from 0 (indicating that the pixel is fully opaque) to 1 (indicating that the pixel is fully transparent). Alternatively, in another representation form, the value may range from 0 (indicating that the pixel is fully opaque) to 255 (indicating that the pixel is fully transparent).

Certainly, the transparency information described above is merely an example. In an actual verification process, the transparency information may also include other information that may represent transparency of a pixel, which is not limited in the present disclosure.

Step S20215: determining, from the pixels of the target icon image, a plurality of second pixels whose transparency information conforms to a preset condition.

In the present disclosure, the second pixel is typically an opaque pixel in the target icon image. If the icon background of the target icon image is a transparent background, the second pixel is a pixel corresponding to an icon element in the target icon image. If the icon background of the target icon image is an opaque background, the second pixel is a pixel corresponding to an icon element and/or the icon background in the target icon image.

If transparency information of a pixel includes transparency of the pixel, a pixel, whose transparency is greater than a first threshold, among the pixels of the target icon image may be determined as a second pixel conforming to the preset condition.

As may be learned from the foregoing description of the value of the alpha channel, a larger value of an alpha channel of a pixel indicates a lower transparency degree of the pixel. Therefore, in this embodiment of the present disclosure, the first threshold may be preset, and if a value of an alpha channel of a pixel is greater than the first threshold through comparing a value of an alpha channel of each of the pixels of the target icon image with the first threshold in sequence, the pixel is determined as a second pixel.

For example, the value of the alpha channel of the pixel may range from 0 to 255. In this case, the first threshold may be 200. Correspondingly, if a value of an alpha channel of a pixel in the target icon image is greater than 200, the pixel may be determined as a second pixel.

Certainly, the first threshold is merely an example. In an actual verification process, the first threshold may alternatively be another value, which is not limited in the present disclosure.

Moreover, if transparency information of a pixel includes opacity of the pixel, a pixel, whose opacity is less than a second threshold, among the pixels of the target icon image may be determined as a second pixel conforming to the preset condition.

As may be learned from the foregoing description of the value of the opacity attribute of the pixel, a smaller opacity attribute value of a pixel indicates a lower transparency degree of the pixel. Therefore, in this embodiment of the present disclosure, the second threshold may be preset, and if a value of an opacity attribute of a pixel is less than the second threshold through comparing a value of an opacity attribute of each of the pixels of the target icon image with the second threshold in sequence, the pixel is determined as a second pixel.

For example, the value of the opacity attribute of the pixel may range from 0 to 255. In this case, the second threshold may be 50. Correspondingly, if a value of an opacity attribute of a pixel in the target icon image is less than 50, the pixel is determined as a second pixel.

Certainly, the second threshold is merely an example. In an actual verification process, the second threshold may alternatively be another value, which is not limited in the present disclosure.

Step S20216: determining second position coordinates of the plurality of second pixels in the target icon image.

Step S20217: determining, from the to-be-verified icon image, the first preset area indicated by third position coordinates corresponding to the second position coordinates in the target icon image.

In step S203, the operation of determining, from at least one stored icon image of the dashboard, a target icon image corresponding to the to-be-verified icon image is disclosed. That the target icon image corresponds to the to-be-verified icon image means that the to-be-verified icon image and the target icon image display same content, that is, the to-be-verified icon image and the target icon image correspond to a same icon, when the display status of the to-be-verified icon image currently displayed on the dashboard is a correct state.

Because the to-be-verified icon image corresponds to the target icon image, if the second pixel is a pixel corresponding to an icon element in the target icon image, the first preset area indicated by the third position coordinates corresponding to the second position coordinates in the target icon image is an area in which the icon element in the to-be-verified icon image is distributed.

The second position coordinates indicate a position of a target icon in the target icon image. The third position coordinates indicate a position of a to-be-verified target in the to-be-verified icon image. Certainly, the second position coordinates may or may not be equal to the third position coordinates. Because the to-be-verified icon image and the target icon image display the same content when the display status of the to-be-verified icon image currently displayed on the dashboard is a correct state, correspondingly, display content indicated by the second position coordinates in a to-be-verified target image is the same as display content indicated by the third position coordinates in the target icon image.

In other words, when the icon background of the target icon image is a transparent background, the first preset area is an area in which the icon element in the to-be-verified icon image is distributed.

In this case, if the icon background of the target icon image is a transparent background, because the first verification value is obtained by verifying the pixels in the first preset area, and the first preset area determined through the solution of this embodiment of the present disclosure is the area in which the icon element in the to-be-verified icon image is distributed, the icon background of the to-be-verified icon image is not considered when the first verification value is determined based on the first preset area. Even if the icon background of the to-be-verified icon image is transparent, the first verification value is not affected by the background image of the dashboard, thereby improving accuracy of verifying the to-be-verified icon image.

Moreover, if the second pixel is a pixel in an area in which the icon element and the icon background in the target icon image are located, the first preset area indicated by the third position coordinates corresponding to the second position coordinates in the target icon image is an area in which the icon element and the icon background in the to-be-verified icon image are distributed. In other words, when the icon background of the target icon image is an opaque background, the first preset area is an area in which the icon element and the icon background in the to-be-verified icon image are distributed.

In this case, because the icon background of the to-be-verified icon image is also an opaque background, even if pixels in the area where the icon element and the icon background in the to-be-verified icon image are distributed are verified to obtain the first verification value, the first verification value is not affected by the background image of the dashboard. Therefore, the solution in this embodiment of the present disclosure may be used not only for verifying a to-be-verified icon image with a transparent background, but also for verifying a to-be-verified icon image with an opaque background, achieving wide applications.

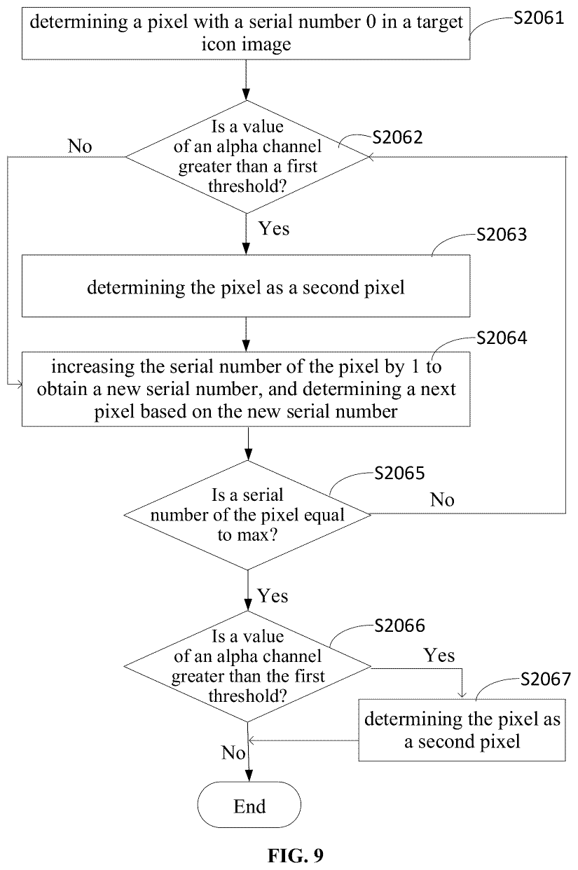

In the embodiment described above, a plurality of second pixels whose transparency information conforms to the preset condition need to be determined based on the transparency information of the pixels of the target icon image. In an example, the second pixels may be determined by traversing the pixels of the target icon image in sequence. In this example, the transparency information of the pixel is a value of an alpha channel of the pixel. In addition, in this example, the pixels of the target icon images are numbered 0, 1, 2, . . . , and MAX, where MAX is a positive integer, and a sum of MAX and 1 is less than or equal to a total number of the pixels of the target icon image. Referring to FIG. 9, this example includes the following steps:

Step S2061: determining a pixel with a serial number 0 in the target icon image.

Step S2062: determining whether a value of an alpha channel of the pixel is greater than the first threshold, and if yes, proceeding to an operation in step S2063.

Step S2063: determining the pixel as a second pixel; and then proceeding to an operation in step S2064.

Step S2064: increasing the serial number of the pixel by 1 to obtain a new serial number, and determining a next pixel based on the new serial number; and then proceeding to an operation in step S2065.

Step S2065: determining whether the new serial number is equal to MAX, and if no, returning to perform the operation in step S2062, or if yes, proceeding to an operation in step S2066.

Step S2066: determining whether a value of an alpha channel of the pixel corresponding to the new serial number is greater than the first threshold, and if yes, proceeding to an operation in step S2067, or if no, ending this operation.

Step S2067: determining the pixel as a second pixel, and ending this operation.

Through the steps described above, the pixels of the target icon image may be traversed in sequence to determine the second pixels of the target icon image.

Certainly, the foregoing manner of determining the second pixels by traversing the pixels of the target icon image is merely an example. In an actual verification process, the second pixels of the target icon image may alternatively be determined in another manner, which is not limited in the present disclosure.

In step S204 of the present disclosure, an operation of determining a second verification value of the target icon image is disclosed. In a feasible implementation of this operation, the second verification value of the target icon image may be determined through the following step: reading the pre-stored second verification value of the target icon image.

In this implementation, the pixels of the target icon image may be verified in advance to determine and store the second verification value. In this case, in a verification process, the stored second verification value may be directly read, thereby improving verification efficiency.

Moreover, in this implementation, a verification manner for the second verification value of the target icon image may be predetermined, which is typically in accordance with a verification manner of determining the first verification value.

That the two verification manners are in accordance with each other that a same verification algorithm is used in the two verification manners, and when the verification algorithm is used to perform verification calculation on pixels in a first distribution area in the to-be-verified icon image and on pixels in a second distribution area in the target icon image, position coordinates of the pixels in the first distribution area are the same as position coordinates of the pixels in the second distribution area in a same coordinate system.

In another feasible implementation, the second verification value of the target icon image may be determined through the following step: determining the second verification value of the target icon image through a verification manner in accordance with a verification manner of determining the first verification value.

In this step, after the target icon image is determined from at least one stored icon image of the dashboard, the second verification value may be determined through a verification manner in accordance with a verification manner of determining the first verification value. Moreover, if the target icon image is stored in a coded form, the target icon image may be decoded after being determined, to determine a decoded target icon image, and then the second verification value is determined for the decoded target icon image.

Through this implementation, the second verification value may still be determined even if the second verification value is not pre-stored, thereby conforming to a verification requirement. For example, as the vehicle industry develops, new icon images to be displayed on the dashboard may appear, but verification values of the newly appearing icon images may not be stored in time. In this case, the second verification value may be determined through such an implementation to conform to the verification requirement comprehensively.

Further, in the foregoing two feasible implementations, the verification manner of determining the second verification value of the target icon image is typically in accordance with the verification manner of determining the first verification value. That the verification manners are in accordance with each other means that a same verification algorithm is used in the two verification manners, and when the verification algorithm is used to perform verification calculation on pixels in a first distribution area in the to-be-verified icon image and on pixels in a second distribution area in the target icon image, position coordinates of the pixels in the first distribution area are the same as position coordinates of the pixels in the second distribution area in a same coordinate system.

For example, if a CRC algorithm is used in the verification manner of determining the first verification value, the same CRC algorithm is used in the verification manner of determining the second verification value. If the first verification value is determined by verifying pixels in a first row to an Nth row in the to-be-verified icon image, the second verification value needs to be determined by verifying pixels in a first row to an Nth row in the target icon image.

Further, in this embodiment of the present disclosure, if the second verification value of the target icon image is determined through a verification manner in accordance with that of determining the first verification value, the second verification value may be stored after being determined. In this way, in a next verification process, the second verification value may be determined by reading the pre-stored second verification value, helping to quickly determine the second verification value in the verification process, thereby improving verification efficiency.

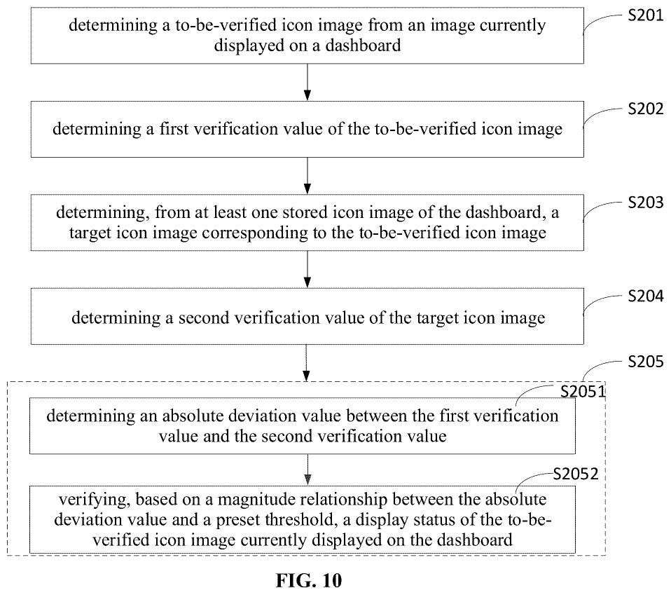

In step S205 of this embodiment of the present disclosure, an operation of verifying, based on the first verification value and the second verification value, a display status of the to-be-verified icon image currently displayed on the dashboard is disclosed. Referring to FIG. 10, based on the foregoing embodiment shown in FIG. 4, in this embodiment of the present disclosure, step S205 may include:

Step S2051: determining an absolute deviation value between the first verification value and the second verification value.

In this embodiment of the present disclosure, the absolute deviation value between the first verification value and the second verification value may be an absolute value of a difference between the two.

Step S2052: verifying, based on a magnitude relationship between the absolute deviation value and a preset threshold, the display status of the to-be-verified icon image currently displayed on the dashboard.

In this embodiment of the present disclosure, a display status of an icon image may include correct display and incorrect display. The absolute deviation value between the first verification value and the second verification value is the smaller, the first verification value and the second verification value are the closer, and correspondingly, a similarity between the to-be-verified icon image and the target icon image is the higher. Therefore, in step S2052, typically, in response to a case that the absolute deviation value is less than the preset threshold, the display status of the to-be-verified icon image is determined to be correct display, and in response to a case that the absolute deviation value is greater than or equal to the preset threshold, the display status of the to-be-verified icon image is determined to be incorrect display.

The preset threshold may be set according to a requirement on verification accuracy. Typically, a higher requirement on verification accuracy indicates a smaller preset threshold.

Through the solution in this embodiment of the present disclosure, verification of the display status of the to-be-verified icon image currently displayed on the dashboard may be implemented based on the magnitude relationship between the preset threshold and the absolute deviation value between the first verification value and the second verification value, thereby conforming to a verification requirement.

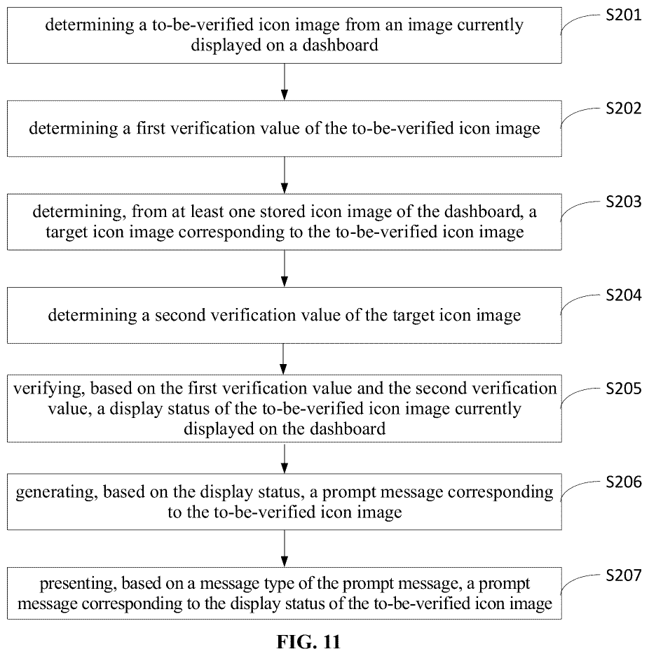

Further, referring to FIG. 11, based on the foregoing embodiment shown in FIG. 4, in this embodiment of the present disclosure, the following steps may be further included:

Step S206: generating, based on the display status, a prompt message corresponding to the to-be-verified icon image.

The prompt message may be in various forms. For example, the prompt message may include audio information transmitted by the vehicle provided with the dashboard, to allow the driver of the vehicle to determine, according to only the audio information, the display status of the to-be-verified icon image displayed on the dashboard, without observing the dashboard. The audio information may include a beep, a ringtone, and/or speech, and the like. Certainly, the audio information may also include another type of information, which is not limited in the present disclosure.

Alternatively, the prompt message may include a preset graphic displayed at a position where the to-be-verified icon image is displayed on the dashboard, to allow the driver to determine the display status of the to-be-verified icon image on the dashboard through the preset graphic when viewing the dashboard. The preset graphic may include an exclamation mark graphic, and/or a character graphic including “ERROR”. Certainly, the preset graphic may also include another graphic, which is not limited in the present disclosure.

Certainly, the prompt message may also include both audio information and a preset graphic to achieve a more comprehensive prompt effect. In addition, the prompt message may also include other forms, which are not limited in the present disclosure.

In a feasible implementation of this embodiment of the present disclosure, a corresponding prompt message is generated only when the display status of the to-be-verified icon image is incorrect display. For example, after the display status of the to-be-verified icon image is determined to be incorrect display, generated display information may include speech audio of “the to-be-verified icon image is displayed abnormally” and/or an exclamation mark graphic displayed at the position where the to-be-verified icon image is displayed on the dashboard.

Alternatively, in another feasible implementation of this embodiment of the present disclosure, for cases that the display status of the to-be-verified icon image is correct display and incorrect display, corresponding prompt messages may be generated and the prompt messages generated in the two cases are different to provide more comprehensive prompts to the driver. For example, after the display status of the to-be-verified icon image is determined to be incorrect display, generated display information may include speech audio of “the to-be-verified icon image is displayed abnormally”. After the display status of the to-be-verified icon image is determined to be normal display, generated display information may include speech audio of “the to-be-verified icon image is displayed normally”.

Step S207: presenting, based on a message type of the prompt message, a prompt message corresponding to the display status of the to-be-verified icon image.

In this step, the prompt message generated in the previous step may be presented to prompt the driver.

The prompt message may serve as a reminder to the driver of the vehicle to reduce occurrence of driving the vehicle under incorrect display of a to-be-verified icon image, thereby improving safety of vehicle driving.

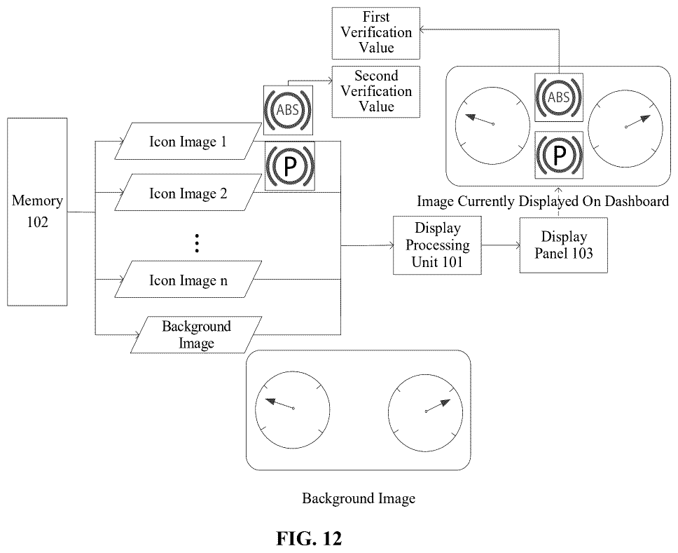

To clarify the verification method provided in the embodiments of the present disclosure, the present disclosure provides an example, as shown in FIG. 12, which is a schematic diagram corresponding to the example. The display processing unit 101 reads respective icon images and the background image of the dashboard from the memory 102. In this example, the icon images stored in the memory 102 include an icon image 1, an icon image 2, . . . , and an icon image n, n being a positive integer. In addition, the icon image 1 read by the display processing unit 101 is the icon image shown in FIG. 1(a), the icon image 2 is the icon image shown in FIG. 1(b), and the background image is an image with two circular instrument dials. Then, the display processing unit 101 superimposes the icon images onto the background image according to positions of the icon images on the dashboard to obtain a superimposed image and then forwards the superimposed image to a display panel 103 of the dashboard, and the display panel 103 displays the superimposed image, thus enabling the image currently displayed on the dashboard to include the icon images.

Referring to FIG. 12, if the icon image shown in FIG. 1(a) needs to be verified, that is, if the icon image shown in FIG. 1(a) is a to-be-verified icon image, the to-be-verified icon image may be determined, based on a distribution position of the to-be-verified icon image in the dashboard, from the image currently displayed on the dashboard, and a first verification value is determined. Next, a corresponding target icon image is read from the memory 102, and a second verification value of a target icon image is determined. Then, a display status of the to-be-verified icon image currently displayed on the dashboard is verified based on the first verification value and the second verification value.

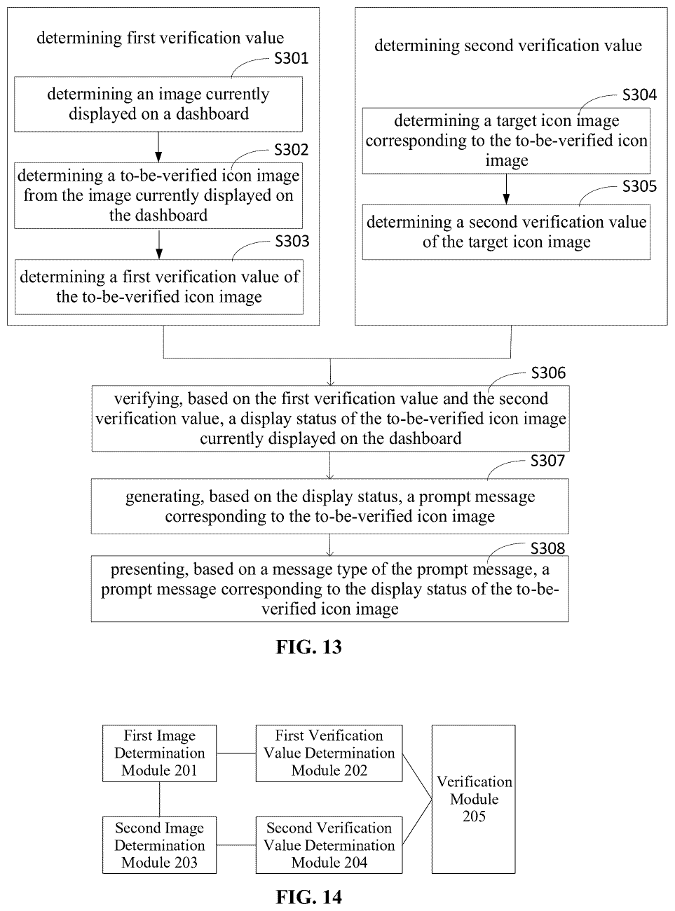

Further, to clarify the verification method provided in the embodiments of the present disclosure, the present disclosure further provides another embodiment. Referring to FIG. 13, in this embodiment, the following steps are included:

Step S301: determining an image currently displayed on a dashboard.

Step S302: determining a to-be-verified icon image from the image currently displayed on the dashboard.

Step S303: determining a first verification value of the to-be-verified icon image.

For the operation of determining the first verification value, refer to the foregoing embodiments. Details are not repeated herein.

Step S304: determining, from at least one stored icon image of the dashboard, a target icon image corresponding to the to-be-verified icon image.

Step S305: determining a second verification value of the target icon image.

For the operation of determining the second verification value, refer to the foregoing embodiments. Details are not repeated herein.

Step S306: verifying, based on the first verification value and the second verification value, a display status of the to-be-verified icon image currently displayed on the dashboard.

Step S307: generating, based on the display status, a prompt message corresponding to the to-be-verified icon image.

Step S308: presenting, based on a message type of the prompt message, a prompt message corresponding to the display status of the to-be-verified icon image.

In other words, through the solution provided in the present disclosure, a display status of an icon image in an image currently displayed on a dashboard may be verified, and a driver may be prompted through a prompt message, to reduce occurrence of the driver driving a vehicle under incorrect display of the icon image, thereby improving safety of vehicle driving.

### Exemplary Apparatus

The following describes an apparatus embodiment of the present disclosure, which may be used for performing the verification method embodiment of the present disclosure. For details not disclosed in the apparatus embodiment of the present disclosure, refer to the verification method embodiment of the present disclosure.

FIG. 14 is a diagram illustrating a structure of a verification apparatus for an icon image of a dashboard according to an exemplary embodiment of the present disclosure. The apparatus may include: a first image determination module 201, a first verification value determination module 202, a second image determination module 203, a second verification value determination module 204, and a verification module 205.

The first image determination module 201 is configured for determining a to-be-verified icon image from an image currently displayed on the dashboard.

The first verification value determination module 202 is configured for determining a first verification value of the to-be-verified icon image determined by the first image determination module 201.

The second image determination module 203 is configured for determining, from at least one stored icon image of the dashboard, a target icon image corresponding to the to-be-verified icon image.

The second verification value determination module 204 is configured for determining a second verification value of the target icon image determined by the second image determination module 203.

The verification module 205 is configured for verifying, based on the first verification value determined by the first verification value determination module 202 and the second verification value determined by the second verification value determination module 204, a display status of the to-be-verified icon image currently displayed on the dashboard.

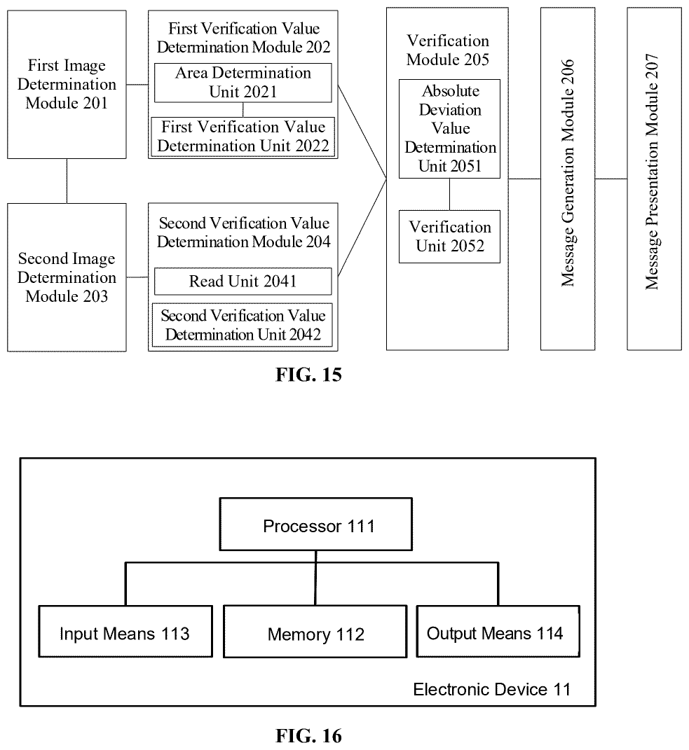

Further, referring to FIG. 15 showing a diagram illustrating a structure, in a feasible implementation, the first verification value determination module 202 includes: an area determination unit 2021 and a first verification value determination unit 2022.

The area determination unit 2021 is configured for determining a first preset area in the to-be-verified icon image.

The first verification value determination unit 2022 is configured for verifying pixels in the first preset area determined by the area determination unit 2021 to determine the first verification value.

In a feasible implementation, the area determination unit 2021 determines the first preset area in the to-be-verified icon image through the following steps:
reading first position coordinates of a pre-stored icon element in the to-be-verified icon image;
identifying, from the to-be-verified icon image, an area corresponding to the icon element indicated by the first position coordinates; and
determining the first preset area from the area corresponding to the icon element.

In another feasible implementation, the area determination unit 2021 determines the first preset area in the to-be-verified icon image through the following steps:
determining transparency information of pixels of the target icon image;
determining, from the pixels of the target icon image, a plurality of second pixels whose transparency information conforms to a preset condition;
determining second position coordinates of the plurality of second pixels in the target icon image; and
determining, from the to-be-verified icon image, the first preset area indicated by third position coordinates corresponding to the second position coordinates in the target icon image.

Further, in a feasible example, the second verification value determination module 204 includes a read unit 2041 or a second verification value determination unit 2042.

The read unit 2041 is configured for reading the pre-stored second verification value of the target icon image. The second verification value determination unit 2042 is configured for determining the second verification value of the target icon image through a verification manner in accordance with a verification manner of determining the first verification value.

Further, in a feasible implementation, the verification module 205 includes an absolute deviation value determination unit 2051 and a verification unit 2052.

The absolute deviation value determination unit 2051 is configured for determining an absolute deviation value between the first verification value and the second verification value.

The verification unit 2052 is configured for verifying, based on a magnitude relationship between the absolute deviation value determined by the absolute deviation value determination unit 2051 and a preset threshold, the display status of the to-be-verified icon image currently displayed on the dashboard.

Further, in a feasible implementation, the verification apparatus further includes a message generation module 206 and a message presentation module 207.

The message generation module 206 is configured for generating, based on the display status, a prompt message corresponding to the to-be-verified icon image.

The message presentation module 207 is configured for presenting, based on a message type of the prompt message generated by the message generation module 206, a prompt message corresponding to the display status of the to-be-verified icon image.

The apparatus provided in the embodiments of the present disclosure may verification a display status of an icon image currently displayed on a dashboard. Further, the apparatus may also enable a driver of a vehicle to determine the display status based on a verification result, helping to reduce occurrence of the driver driving the vehicle under incorrect display of a to-be-verified icon image, thereby helping to improve safety of vehicle driving.

### Exemplary Electronic Device

FIG. 16 is a diagram illustrating a structure of an electronic device according to an embodiment of the present disclosure. The electronic device includes at least one processor 111 and a memory 112.

The processor 111 may be a central processing unit (CPU) or another form of processing unit having a data processing capability and/or an instruction execution capability, and may control another component in the electronic device 11 to perform a desired function.

The memory 112 may include one or more computer program products. The computer program product may include various forms of computer readable storage media, such as a volatile memory and/or a non-volatile memory. The volatile memory may include, for example, a random access memory (RAM) and/or a cache. The non-volatile memory may include, for example, a read-only memory (ROM), a hard disk, or a flash memory. The computer readable storage medium may store one or more computer program instructions. The processor 111 may run the one or more computer program instructions to implement the verification method for an icon image of a dashboard and/or other desired functions in the foregoing embodiments of the present disclosure.

In an example, the memory 112 may store at least one icon image of the dashboard and may also store a background image of the dashboard.

In an example, the electronic device 11 may further include: an input means 113 and an output means 114. The components are interconnected through a bus system and/or other forms of connection mechanisms (not shown).

The output means 114 may output various information to the outside, and may include, for example, a display, a loudspeaker, a printer, and a communication network and a remote output means connected thereto. For example, the output means 114 may include the dashboard, which may display an icon. In addition, when the output means 114 includes a loudspeaker, an audio message in a prompt message corresponding to a to-be-verified icon image may be played through the loudspeaker. When the output means 114 includes a remote output means, after a display status of the to-be-verified icon image currently displayed on the dashboard is obtained through verification, the display status may be output, so that a user on the remote output means side gets to know the display status.

Certainly, for simplicity, only some components in the electronic device 11 that are related to the present disclosure are shown in FIG. 16, and components such as a bus and an input/output interface are omitted. Besides, the electronic device 11 may further include any other appropriate components depending on specific applications.

### Exemplary Computer Program Product And Computer Readable Storage Medium

In addition to the foregoing method and device, the embodiments of the present disclosure may also provide a computer program product including computer program instructions that, when run by a processor, cause the processor to perform the steps of the verification method for an icon image of a dashboard according to the embodiments of the present disclosure that is described in the “exemplary method” section.

The computer program product may be program code, written with one or any combination of a plurality of programming languages, that is configured for performing the operations in the embodiments of the present disclosure. The programming languages include an object-oriented programming language such as Java or C++, and further include a conventional procedural programming language such as a “C” language or a similar programming language. The program code may be entirely or partially executed on a user computing device, executed as an independent software package, partially executed on the user computing device and partially executed on a remote computing device, or entirely executed on the remote computing device or a server.

In addition, the embodiments of the present disclosure may further relate to a computer readable storage medium, on which computer program instructions are stored. The computer program instructions, when run by a processor, cause the processor to perform the steps of the verification method for an icon image of a dashboard according to the embodiments of the present disclosure that is described in the “exemplary method” section.

The computer readable storage medium may be one readable medium or any combination of a plurality of readable media. The readable medium may be a readable signal medium or a readable storage medium. The readable storage medium includes, for example, but is not limited to electrical, magnetic, optical, electromagnetic, infrared, or semiconductor systems, apparatuses, or devices, or any combination of the above. More specific examples (a non-exhaustive list) of the readable storage medium include: an electrical connection with one or more conducting wires, a portable disk, a hard disk, a RAM, a ROM, an EPROM or a flash memory, an optical fiber, a portable compact disk ROM (CD-ROM), an optical storage device, a magnetic storage device, or any suitable combination of the above.

Basic principles of the present disclosure are described above in combination with specific embodiments. However, the advantages, superiorities, effects, and the like mentioned in the present disclosure are merely examples rather than limitations, and it should not be considered that these advantages, superiorities, effects, and the like are necessary for each of the embodiment of the present disclosure. In addition, specific details disclosed above are merely for examples and for ease of understanding, rather than limitations. The details described above do not limit that the present disclosure must be implemented by using the foregoing specific details.

A person skilled in the art may make various modifications and variations to the present disclosure without departing from the spirit and scope of this application. The present disclosure is intended to cover these modifications and variations provided that they fall within the scope of protection defined by the claims of the present disclosure or equivalents thereof.

What is claimed is:

1. A verification method for an icon image of a dashboard, comprising:
determining a to-be-verified icon image from an image currently displayed on the dashboard;
determining a first verification value of the to-be-verified icon image;
determining, from at least one stored icon image of the dashboard, a target icon image corresponding to the to-be-verified icon image;
determining a second verification value of the target icon image; and
verifying, based on the first verification value and the second verification value, a display status of the to-be-verified icon image currently displayed on the dashboard.

2. The verification method according to claim 1, wherein the determining a first verification value of the to-be-verified icon image comprises:
determining a first preset area in the to-be-verified icon image; and
verifying pixels in the first preset area to determine the first verification value.

3. The verification method according to claim 2, wherein the determining a first preset area in the to-be-verified icon image comprises:
reading first position coordinates of a pre-stored icon element in the to-be-verified icon image;
identifying, from the to-be-verified icon image, an area corresponding to the icon element indicated by the first position coordinates; and
determining the first preset area from the area corresponding to the icon element.

4. The verification method according to claim 2, wherein the determining a first preset area in the to-be-verified icon image comprises:
determining transparency information of pixels of the target icon image;
determining, from the pixels of the target icon image, a plurality of second pixels whose transparency information conforms to a preset condition;
determining second position coordinates of the plurality of second pixels in the target icon image; and
determining, from the to-be-verified icon image, the first preset area indicated by third position coordinates corresponding to the second position coordinates in the target icon image.

5. The verification method according to claim 1, wherein the determining a second verification value of the target icon image comprises:
reading the second verification value, which is pre-stored, of the target icon image; or
determining the second verification value of the target icon image in a verification manner in accordance with a verification manner of determining the first verification value.

6. The verification method according to claim 1, wherein the verifying, based on the first verification value and the second verification value, a display status of the to-be-verified icon image currently displayed on the dashboard comprises:
determining an absolute deviation value between the first verification value and the second verification value; and
verifying, based on a magnitude relationship between the absolute deviation value and a preset threshold, the display status of the to-be-verified icon image currently displayed on the dashboard.

7. The verification method according to claim 6, wherein the verification method further comprises:
generating, based on the display status, a prompt message corresponding to the to-be-verified icon image; and
presenting, based on a message type of the prompt message, a prompt message corresponding to the display status of the to-be-verified icon image.

8. The verification method according to claim 2, wherein the verifying, based on the first verification value and the second verification value, a display status of the to-be-verified icon image currently displayed on the dashboard comprises:
determining an absolute deviation value between the first verification value and the second verification value; and
verifying, based on a magnitude relationship between the absolute deviation value and a preset threshold, the display status of the to-be-verified icon image currently displayed on the dashboard.

9. The verification method according to claim 3, wherein the verifying, based on the first verification value and the second verification value, a display status of the to-be-verified icon image currently displayed on the dashboard comprises:
determining an absolute deviation value between the first verification value and the second verification value; and
verifying, based on a magnitude relationship between the absolute deviation value and a preset threshold, the display status of the to-be-verified icon image currently displayed on the dashboard.

10. The verification method according to claim 4, wherein the verifying, based on the first verification value and the second verification value, a display status of the to-be-verified icon image currently displayed on the dashboard comprises:
determining an absolute deviation value between the first verification value and the second verification value; and
verifying, based on a magnitude relationship between the absolute deviation value and a preset threshold, the display status of the to-be-verified icon image currently displayed on the dashboard.

11. A non-transitory computer readable storage medium, on which a computer program is stored, wherein the computer program, when executed by a processor, causes the processor to implement a verification method for an icon image of a dashboard, wherein the verification method comprises:
determining a to-be-verified icon image from an image currently displayed on the dashboard;
determining a first verification value of the to-be-verified icon image;
determining, from at least one stored icon image of the dashboard, a target icon image corresponding to the to-be-verified icon image;
determining a second verification value of the target icon image; and
verifying, based on the first verification value and the second verification value, a display status of the to-be-verified icon image currently displayed on the dashboard.

12. An electronic device comprising:
a processor; and
a memory configured for storing instructions executable by the processor, wherein
the processor is configured for reading the executable instructions from the memory and executing the instructions to implement a verification method for an icon image of a dashboard, wherein the verification method comprises:
determining a to-be-verified icon image from an image currently displayed on the dashboard;
determining a first verification value of the to-be-verified icon image;
determining, from at least one stored icon image of the dashboard, a target icon image corresponding to the to-be-verified icon image;
determining a second verification value of the target icon image; and
verifying, based on the first verification value and the second verification value, a display status of the to-be-verified icon image currently displayed on the dashboard.

13. The electronic device according to claim 12, wherein the determining a first verification value of the to-be-verified icon image comprises:
determining a first preset area in the to-be-verified icon image; and
verifying pixels in the first preset area to determine the first verification value.

14. The electronic device according to claim 13, wherein the determining a first preset area in the to-be-verified icon image comprises:
reading first position coordinates of a pre-stored icon element in the to-be-verified icon image;
identifying, from the to-be-verified icon image, an area corresponding to the icon element indicated by the first position coordinates; and
determining the first preset area from the area corresponding to the icon element.

15. The electronic device according to claim 13, wherein the determining a first preset area in the to-be-verified icon image comprises:
determining transparency information of pixels of the target icon image;
determining, from the pixels of the target icon image, a plurality of second pixels whose transparency information conforms to a preset condition;
determining second position coordinates of the plurality of second pixels in the target icon image; and
determining, from the to-be-verified icon image, the first preset area indicated by third position coordinates corresponding to the second position coordinates in the target icon image.

16. The electronic device according to claim 14, wherein the determining a second verification value of the target icon image comprises:
reading the second verification value, which is pre-stored, of the target icon image; or
determining the second verification value of the target icon image in a verification manner in accordance with a verification manner of determining the first verification value.

17. The electronic device according to claim 12, wherein the verifying, based on the first verification value and the second verification value, a display status of the to-be-verified icon image currently displayed on the dashboard comprises:
determining an absolute deviation value between the first verification value and the second verification value; and
verifying, based on a magnitude relationship between the absolute deviation value and a preset threshold, the display status of the to-be-verified icon image currently displayed on the dashboard.

18. The electronic device according to claim 17, wherein the verification method further comprises:
generating, based on the display status, a prompt message corresponding to the to-be-verified icon image; and
presenting, based on a message type of the prompt message, a prompt message corresponding to the display status of the to-be-verified icon image.

19. The electronic device according to claim 13, wherein the verifying, based on the first verification value and the second verification value, a display status of the to-be-verified icon image currently displayed on the dashboard comprises:
determining an absolute deviation value between the first verification value and the second verification value; and
verifying, based on a magnitude relationship between the absolute deviation value and a preset threshold, the display status of the to-be-verified icon image currently displayed on the dashboard.

20. The electronic device according to claim 14, wherein the verifying, based on the first verification value and the second verification value, a display status of the to-be-verified icon image currently displayed on the dashboard comprises:
determining an absolute deviation value between the first verification value and the second verification value; and
verifying, based on a magnitude relationship between the absolute deviation value and a preset threshold, the display status of the to-be-verified icon image currently displayed on the dashboard.
